(19) United States
(12) Patent Application Publication
(10) Pub. No.: US 2025/0072692 A1
(43) Pub. Date: Mar. 6, 2025

(54) CLEANING METHOD FOR CLEANING DEVICE, ROBOT VACUUM CLEANER, AND STORAGE MEDIUM

(71) Applicants: GREE ELECTRIC APPLIANCES, INC. OF ZHUHAI, Zhuhai (CN); LEAYUN TECHNOLOGY CO., LTD. OF ZHUHAI, Zhuhai (CN)

(72) Inventors: Shaofeng GUO, Zhuhai (CN); Yanyu CHEN, Zhuhai (CN); Yaqi MA, Zhuhai (CN); Li ZHANG, Zhuhai (CN); Gao CHEN, Zhuhai (CN); Boyang GUO, Zhuhai (CN)

(73) Assignees: GREE ELECTRIC APPLIANCES, INC. OF ZHUHAI, Zhuhai (CN); LEAYUN TECHNOLOGY CO., LTD. OF ZHUHAI, Zhuhai (CN)

(21) Appl. No.: 18/953,052

(22) Filed: Nov. 19, 2024

Related U.S. Application Data
(63) Continuation of application No. PCT/CN2022/144260, filed on Dec. 30, 2022.

(30) Foreign Application Priority Data
May 25, 2022 (CN) 202210577478.5

(51) Int. Cl. A47L 11/40; G05D 1/648

(52) U.S. Cl. CPC A47L 11/4011; A47L 11/4008; G05D 1/648

(57) ABSTRACT

A cleaning method for a cleaning device includes: acquiring a grid map of a region to be cleaned; dividing a passable region in the grid map into a plurality of candidate regions; screening the plurality of candidate regions; prioritizing a plurality of screened candidate regions, and corresponding the plurality of screened candidate regions with different priorities to different cleaning parameters; and cleaning the plurality of screened candidate regions according to priority sorting, the cleaning parameters include at least one of a cleaning frequency, cleaning time, cleaning agent addition information and a cleaning mode. Adopting the cleaning method for the cleaning device effectively solves problems in that cleaning efficiency of a robot vacuum cleaner is relatively low in related technologies.

### CROSS-REFERENCE TO RELATED APPLICATIONS

This application is a continuation of International Application No. PCT/CN2022/144260, filed on Dec. 30, 2022, which claims priority to Chinese Patent Application No. 202210577478.5, filed on May 25, 2022. The disclosures of the aforementioned applications are hereby incorporated by reference in their entireties.

### TECHNICAL FIELD

The present application relates to the field of cleaning device technologies, and in particular, to a cleaning method for a cleaning device, a robot vacuum cleaner, and a storage medium.

### BACKGROUND

At present, with the development of computers and artificial intelligence technologies, a robot vacuum cleaner has become a powerful assistant for cleaning. However, during cleaning, different regions to be cleaned correspond to different cleaning requirements, which are not considered in related technologies, thus affecting cleaning efficiency of the robot vacuum cleaner.

### SUMMARY

Main purposes of the present application are to provide a cleaning method for a cleaning device, a robot vacuum cleaner, and a storage medium, so as to solve problems in that cleaning efficiency of a robot vacuum cleaner is relatively low in related technologies.

In order to achieve the above purposes, according to an aspect of the present application, a cleaning method for a cleaning device is provided, including: acquiring a grid map of a region to be cleaned; dividing a passable region in the grid map into a plurality of candidate regions; screening the plurality of candidate regions; prioritizing a plurality of screened candidate regions, and corresponding the plurality of screened candidate regions with different priorities to different cleaning parameters; and cleaning the plurality of screened candidate regions according to priority sorting. The cleaning parameters include at least one of a cleaning frequency, cleaning time, cleaning agent addition information and a cleaning mode.

In an optional embodiment, the dividing a passable region in the grid map into a plurality of candidate regions includes: with each pixel in the passable region as a center, extending radially until a non-passable region in the grid map is reached, so as to obtain a plurality of regions with preset shapes, and determining the plurality of regions with preset shapes as the plurality of candidate regions.

In an optional embodiment, the screening the plurality of candidate regions includes: determining at least one set of candidate regions with an intersecting relationship in the plurality of candidate regions; and reserving a candidate region with an area greater than a preset threshold in each of the at least one set of candidate regions.

In an optional embodiment, after each screening of a plurality of candidate regions, a reserved candidate region is shielded, and then a remaining passable region, excluding the reserved candidate region, is divided into a plurality of candidate regions, the process continues until a size of each candidate region obtained through division is less than or equal to a cleaning size of a cleaning device.

In an optional embodiment, the cleaning method for the cleaning device further includes: deleting an invalid candidate region.

In an optional embodiment, the deleting an invalid candidate region includes: deleting a candidate region with a size less than or equal to a cleaning size of a cleaning device.

In an optional embodiment, the prioritizing a plurality of screened candidate regions includes: determining a screened candidate region with a size greater than a first preset value in the plurality of screened candidate regions as a first priority region; determining a screened candidate region with a size greater than or equal to a second preset value and less than or equal to the first preset value in the plurality of screened candidate regions as a second priority region; and determining a screened candidate region with a size less than the second preset value in the plurality of screened candidate regions as a third priority region; the second preset value is less than the first preset value.

In an optional embodiment, the prioritizing a plurality of screened candidate regions further includes: determining a screened candidate region that is tangent to or in contact with the first priority region as the first priority region.

In an optional embodiment, the prioritizing a plurality of screened candidate regions further includes: determining a region formed by at least three third priority regions that are tangent to each other as a complex region.

In an optional embodiment, the prioritizing a plurality of screened candidate regions further includes: determining the third priority region that is tangent to the second priority region as the second priority region, and in a case that the second priority region has been determined as the first priority region, determining the third priority region that is tangent to the second priority region as the first priority region.

In an optional embodiment, the prioritizing a plurality of screened candidate regions further includes: determining the third priority region isolated in the grid map as a nook and cranny region.

In an optional embodiment, in a case that the cleaning parameters comprise the cleaning frequency, the corresponding the plurality of screened candidate regions with different priorities to different cleaning parameters includes: determining the cleaning frequency for the first priority region to be at least once a day; and determining the cleaning frequency for the second priority region to be at least once every two days.

In an optional embodiment, in a case that the cleaning parameters comprise the cleaning time, the corresponding the plurality of screened candidate regions with different priorities to different cleaning parameters further includes: determining the cleaning time for the complex region to be post-meal.

In an optional embodiment, in a case that the cleaning parameters comprise the cleaning frequency, the corresponding the plurality of screened candidate regions with different priorities to different cleaning parameters further includes: determining the cleaning frequency for the complex region and the cleaning frequency for the nook and cranny region to be at least once a week.

In an optional embodiment, in a case that the cleaning parameters comprise the cleaning frequency and the cleaning time, the corresponding the plurality of screened candidate regions with different priorities to different cleaning parameters further includes: determining the cleaning time for the complex region to be post-meal; and determining the cleaning frequency of the complex region and the cleaning frequency of the nook and cranny region to be at least once a week.

In an optional embodiment, the cleaning the plurality of screened candidate regions according to priority sorting includes: a) as for screened candidate regions with a same priority, determining a screened candidate region with a largest size, in screened candidate regions with a same priority and closest to a cleaning device, as a priority cleaning region, and cleaning the priority cleaning region; b) cleaning remaining screened candidate regions that are tangent to the priority cleaning region, and are in the screened candidate regions with a same priority, in a clockwise direction; and repeating the step a) and the step b) until the plurality of screened candidate regions with different priorities have been completely cleaned.

In an optional embodiment, the cleaning the plurality of screened candidate regions includes: cleaning each screened candidate region using a spiral cleaning path, starting at a center of the screened candidate region.

In an optional embodiment, the cleaning remaining screened candidate regions that are tangent to the priority cleaning region, and are in the screened candidate regions with a same priority, in a clockwise direction includes: selecting the remaining screened candidate regions that are tangent to the priority cleaning region, and are in the screened candidate regions with a same priority, in the clockwise direction, sequentially; and entering each remaining screened candidate region through a gap between the remaining screened candidate region and the priority cleaning region, and cleaning the remaining screened candidate region using a spiral cleaning path, starting at a center of the remaining screened candidate region.

According to another aspect of the present application, a robot vacuum cleaner is provided, including: a processor, a communication interface, a memory, and a communication bus, and the processor, the communication interface, and the memory communicate with each other through the communication bus; the memory is configured to store a computer program; and the processor is configured to execute the computer program stored in the memory, implementing the cleaning method for the cleaning device described in any of the above embodiments.

According to another aspect of the present application, a non-transitory computer-readable storage medium is provided, a computer program is stored on the non-transitory computer-readable storage medium, and when the computer program is executed by a processor, the cleaning method for the cleaning device described in any of the above embodiments is implemented.

According to another aspect of the present application, a robot vacuum cleaner is provided, and the robot vacuum cleaner is configured to perform the cleaning method for the cleaning device described in any of the above embodiments.

According to another aspect of the present application, a robot vacuum cleaner is provided, including: an acquiring unit configured to acquire a grid map of a region to be cleaned; a dividing unit configured to divide a passable region in the grid map into a plurality of candidate regions; a screening unit configured to screen the plurality of candidate regions; a prioritizing unit configured to prioritize a plurality of screened candidate regions, and correspond the plurality of screened candidate regions with different priorities to different cleaning parameters; and a cleaning unit configured to clean the plurality of screened candidate regions according to priority sorting. The cleaning parameters include at least one of a cleaning frequency, cleaning time, cleaning agent addition information and a cleaning mode.

The cleaning method for the cleaning device of the present application is applied, the passable region is first divided into the plurality of candidate regions, the plurality of candidate regions are screened, and then the plurality of screened candidate regions are prioritized, and the plurality of screened candidate regions with different priorities correspond to different cleaning parameters, so that a cleaning device may clean the plurality of screened candidate regions according to the priority sorting, which makes an optimized cleaning strategy better meet cleaning requirements of users. Compared to related technologies that do not consider different cleaning requirements for different regions to be cleaned, in the cleaning method for the cleaning device of the present application, the plurality of screened candidate regions are prioritized, and a cleaning strategy for the passable region is customized based on different cleaning parameters and different priorities, so as to solve the problems in that cleaning efficiency of a robot vacuum cleaner is relatively low in related technologies, thereby improving cleaning efficiency of a cleaning device, and thus avoiding energy waste and improving users' experience.

### BRIEF DESCRIPTION OF THE DRAWINGS

The accompanying drawings that form part of the specification of the present application, are used to provide a further understanding of the present application, the exemplary embodiments of the present application and the description thereof are used to explain the present application and do not constitute an improper limitation on the present application.

FIG. 1 is a flowchart of a cleaning method for a cleaning device according to an embodiment of the present application.

FIG. 2 is a schematic diagram of a grid map according to an embodiment of the present application.

FIG. 3 is a logic diagram of a cleaning method for a cleaning device according to an embodiment of the present application.

FIG. 4 is a schematic diagram of three candidate regions that intersect each other in the grid map in FIG. 2.

FIG. 5 is a schematic diagram of the grid map in FIG. 2 after priority sorting is completed.

FIG. 6 is a schematic diagram of a cleaning path of a cleaning device.

FIG. 7 is a block diagram of a robot vacuum cleaner according to an embodiment of the present application.

### DETAILED DESCRIPTION OF THE EMBODIMENTS

It should be noted that the embodiments of the present application or features in the embodiments may be combined with each other without conflict. The present application is described in detail below with reference to the accompanying drawings and in combination with the embodiments.

It should be pointed out that, unless otherwise specified, all technical terms and scientific terms used in the present application have the same meanings as those commonly understood by ordinary technicians in the technical field to which the present application belongs.

In the present application, unless otherwise stated, directional words such as “above” and “below” are usually referred to the directions shown in the accompanying drawings, or the vertical direction, the perpendicular direction or the gravitational direction; similarly, for ease of understanding and description, directional words “left” and “right” are usually referred to the left and right shown in the accompanying drawings; and directional words “inside” and “outside” are referred to inner and outer contours of each component itself. However, the above directional words are not intended to limit the present application.

At present, with the development of computers and artificial intelligence technologies, a robot vacuum cleaner has become a powerful assistant for household cleaning. During the process of using the robot vacuum cleaner, s sensor equipped on the robot vacuum cleaner is used to perceive home environment in which the robot vacuum cleaner is located, a two-dimensional grid map is established through a Simultaneous Localization and Mapping (SLAM) algorithm, and then a cleaning path is calculated and planed, so as to realize automatic cleaning of home floor. In order to improve cleaning efficiency, the home environment is typically divided into many regions according to a map, and then each divided region is cleaned one by one. Essentially, all passable regions are treated equally.

However, regions in the home environment that are frequently used by people (such as around the tea table of the living room, around the dining table, or in bedrooms) tend to accumulate dirt more quickly and require more frequent cleaning. In contrast, regions that are not on a living line (such as corners of a room, or far ends of hallways) require relatively low-frequency cleaning. A method of uniformly cleaning all passable regions in related technologies does not specifically take into account these different cleaning requirements, which affects cleaning efficiency of a robot vacuum cleaner.

In order to solve problems in that cleaning efficiency of a robot vacuum cleaner is relatively low in related technologies, the preset application provides a cleaning method for a cleaning device, a robot vacuum cleaner, and a storage medium.

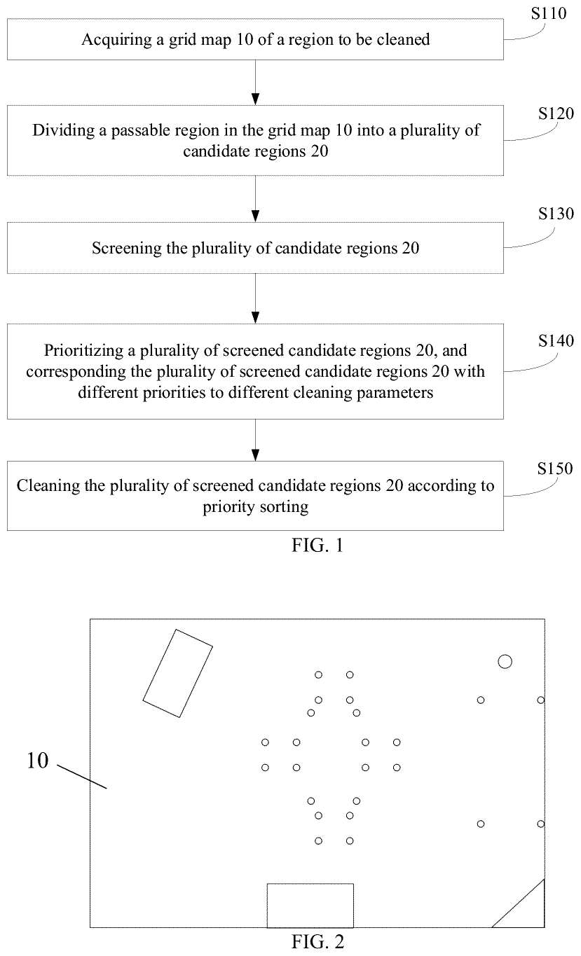

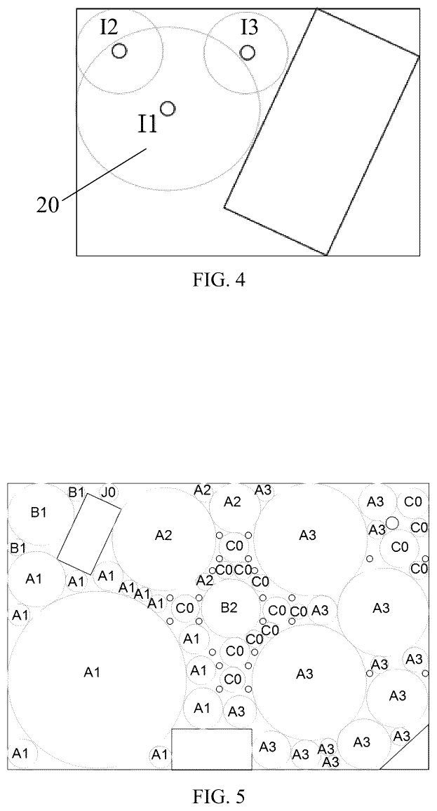

A cleaning method of a cleaning device described in FIG. 1 is performed by a computing device (for example, a server), but the embodiments of the present application are not so limited. As shown in FIG. 1, FIG. 2, and FIG. 4 to FIG. 6, the cleaning method for the cleaning device includes:
S110, acquiring a grid map 10 of a region to be cleaned;
S120, dividing a passable region in the grid map 10 into a plurality of candidate regions 20;
S130, screening the plurality of candidate regions 20;
S140, prioritizing a plurality of screened candidate regions 20, and corresponding the plurality of screened candidate regions 20 with different priorities to different cleaning parameters; and
S150, cleaning the plurality of screened candidate regions 20 according to priority sorting.

The cleaning parameters include at least one of a cleaning frequency, cleaning time, cleaning agent addition information and cleaning mode.

The cleaning method for the cleaning device of the present application is applied, the passable region is first divided into the plurality of candidate regions, the plurality of candidate regions are screened, and then the plurality of screened candidate regions are prioritized, and the plurality of screened candidate regions with different priorities correspond to different cleaning parameters, so that a cleaning device may clean the plurality of screened candidate regions according to the priority sorting, which makes an optimized cleaning strategy better meet cleaning requirements of users. Compared to related technologies that do not consider different cleaning requirements for different regions to be cleaned, in the cleaning method for the cleaning device of the present application, the plurality of screened candidate regions are prioritized, and a cleaning strategy for the passable region is customized based on different cleaning parameters and different priorities, so as to solve the problems in that cleaning efficiency of a robot vacuum cleaner is relatively low in related technologies, thereby improving cleaning efficiency of a cleaning device, and thus avoiding energy waste and improving users' experience.

In this embodiment, the cleaning mode include a pure sweeping mode, a pure suction mode, a suction-sweeping mode, a linear scraping mode or a rotary sweeping mode, etc.

Optionally, the dividing a passable region in the grid map 10 into a plurality of candidate regions 20 includes:
with each pixel in the passable region as a center, extending radially until a non-passable region in the grid map 10 is reached, so as to obtain a plurality of regions with preset shapes, and determining the plurality of regions with preset shapes as the plurality of candidate regions 20.

For example, a method for forming a circular region or a polygonal region involves using each pixel in the passable region as the center and extending radially from the center until an outer edge of the circular region or an outer edge of the polygonal region reaches to the non-passable region in the grid map 10. At this time, each circular region or each polygonal region becomes the candidate region 20.

Specifically, a method for dividing the passable region into the candidate regions 20 adopts a flooding algorithm, which involves taking each pixel in the passable region as the center and extending radially from the center to form the circular region or the polygonal region. During the extension process, once an unreachable pixel is encountered, region expansion is completed, and the circular region or the polygonal region is taken as the candidate region 20, so that an amount of candidate regions 20 is consistent with an amount of pixels contained in the passable region of the entire grid map 10. At this time, division of the candidate regions 20 is completed, thereby improving problems of a traditional robot vacuum cleaner having unreasonable divisions in a cleaning map for home scenarios, and thus enhancing cleaning efficiency of a cleaning device.

In this embodiment, a method for dividing a passable region in the grid map 10 into a plurality of candidate regions 20 includes: with each pixel in the passable region as a center, extending radially from the center to form a circular region until an outer edge of the circular region reaches a non-passable region in the grid map 10, and determining each circular region as the candidate region 20 at this time. In this way, the above setting makes the division of the candidate regions 20 easier and more convenient, and thus reducing division difficulty.

It should be noted that a shape of the region formed by extending radially from each pixel in the passable region is not limited thereto, and the shape may be adjusted according to usage requirements and working conditions. Optionally, shapes such as a rectangular region, a square region, an elliptical region, or a triangular region are formed by extending radially from each pixel in the passable region.

In this embodiment, the screening the plurality of candidate regions 20 includes:
determining at least one set of candidate regions 20 with an intersecting relationship in the plurality of candidate regions 20; and
reserving a candidate region 20 with an area greater than a preset threshold in each of the at least one set of candidate regions 20.

For example, in a case that two candidate regions 20 intersect each other, one candidate region 20 with a relatively large area in the two candidate regions 20 is reserved.

As shown in FIG. 4, I1, I2 and I3 are three candidate regions 20 in the grid map 10, a principle of screening is to reserve only one candidate region with the largest area among all intersecting candidate regions 20, and therefore, only the I1 is reserved after the screening. At this time, it is considered that one round of fine division is completed.

In this embodiment, after each screening of a plurality of candidate regions 20, a reserved candidate region 20 is shielded, and then a remaining passable region 20, excluding the reserved candidate region 20, is divided into a plurality of candidate regions 20, the process continues until a size of each candidate region 20 obtained through division is less than or equal to a cleaning size of a cleaning device. For example, in a case that a shape of the candidate region 20 is circular, a radius of each candidate region 20 is less than or equal to a cleaning radius of the cleaning device.

Specifically, after each round of the fine division is completed, all pixels in the candidate region 20 divided by this round are shielded from the passable region, and then the remaining passable region is repeatedly divided until there is no candidate region 20 with a radius greater than the cleaning radius of the cleaning device in the passable region in the grid map 10.

In this embodiment, after the plurality of screened candidate regions are obtained, the cleaning method for the cleaning device further includes: deleting an invalid candidate region 20.

Specifically, the passable region is first divided into the plurality of candidate regions 20, the invalid candidate region is deleted from the plurality of screened candidate regions 20, and then the plurality of screened candidate regions 20 are prioritized, so that the plurality of screened candidate regions 20 with different priorities correspond to different cleaning parameters.

In this embodiment, the deleting an invalid candidate region 20 includes:
deleting a candidate region 20 with a size less than or equal to a cleaning size of a cleaning device.

For example, in a case that a shape of the candidate region 20 is circular, the candidate region 20 with a radius less than the cleaning radius of the cleaning device is deleted.

Specifically, all divided candidate regions 20 are screened, so as to eliminate the candidate region 20 with a radius less than the cleaning radius, thereby completing the division of the entire grid map 10. FIG. 5 shows the effect of the completed division of the grid map.

In this embodiment, the prioritizing a plurality of screened candidate region 20 includes:
determining a screened candidate region 20 with a size (such as a radium) greater than a first preset value in the plurality of screened candidate regions 20 as a first priority region A;
determining a screened candidate region 20 with a size (such as a radium) greater than or equal to a second preset value and less than or equal to the first preset value in the plurality of screened candidate regions 20 as a second priority region B; and
determining a screened candidate region 20 with a size (such as a radium) less than the second preset value in the plurality of screened candidate regions 20 as a third priority region C.

The second preset value is less than the first preset value.

Optionally, the first preset value is 1 m, and the second preset value is 0.5 m. Specifically, all the screened candidate regions 20 with a radium greater than 1 m are determined as the first priority region A, the screened candidate regions 20 with a radium ranging from 0.5 m to 1 m are determined as the second priority region B, and the screened candidate regions 20 with a radius less than 0.5 m are determined as the third priority region C. The effect of pre-sorting is shown in FIG. 5, the first priority region A in the grid map 10 includes A1, A2 and A3, and the second priority region B includes B1 and B2.

In this embodiment, the prioritizing a plurality of screened candidate regions 20 further includes:
determining a screened candidate region 20 that is tangent to or in contact with the first priority region A as the first priority region A.

Specifically, the screened candidate region 20 that is tangent to the first priority region A in the pre-sorted grid map 10 is merged into the corresponding first priority region A, so as to form the first priority region A after a second round of sorting, where the cleaning frequency for all the screened candidate regions 20 are consistent, and the cleaning time for all the screened candidate regions 20 are consistent.

In this embodiment, the prioritizing a plurality of screened candidate regions 20 further includes:
determining a region formed by at least three third priority regions C that are tangent to each other as a complex region C0.

Specifically, in the remaining third priority regions C, in a case that there are more than three screened candidate regions 20 that are tangent to each other, it is determined that these screened candidate regions 20 belong to the complex region C0, thereby making the priority division of the plurality of screened candidate regions 20 in the grid map 10 more reasonable.

In this embodiment, the prioritizing a plurality of screened candidate regions 20 further includes:
determining the third priority region C that is tangent to the second priority region B as the second priority region B, and in a case that the second priority region B has been determined as the first priority region A, determining the third priority region C that is tangent to the second priority region B as the first priority region A.

Specifically, in the remaining third priority regions C, in a case that there are more than three screened candidate regions 20 that are tangent to each other, it is determined that these screened candidate regions 20 belong to the complex region C0. Otherwise, in the remaining third priority regions C, in a case that the screened candidate region 20 is tangent to the second priority region B, the screened candidate region 20 is merged into the corresponding second priority region B, and in a case that the second priority region B has been merged into the first priority region A, the screened candidate region 20 that is tangent to the second priority region B is correspondingly merged into the first priority region A, where the cleaning frequency for all the screened candidate regions 20 are consistent, and the cleaning time for all the screened candidate regions 20 are consistent.

In this embodiment, the prioritizing a plurality of screened candidate regions 20 further includes:
determining the third priority region C isolated in the grid map 10 as a nook and cranny region J0.

Specifically, the third priority region C isolated in the grid map 10 is divided into the nook and cranny region J0, thereby making the priority division of the plurality of screened candidate regions 20 in the grid map 10 more reasonable. In this way, the circular regions in the entire grid map 10 are sorted into: the first priority region A, the second priority region B, the complex region C0 and the nook and cranny region J0, and the effect after the sorting is completed is shown in FIG. 5.

Optionally, in a case that the cleaning parameters include the cleaning frequency, the corresponding the plurality of screened candidate regions with different priorities to different cleaning parameters includes:
determining the cleaning frequency for the first priority region A to be at least once a day; and
determining the cleaning frequency for the second priority region B to be at least once every two days.

Optionally, in a case that the cleaning parameters include the cleaning time, the corresponding the plurality of screened candidate regions with different priorities to different cleaning parameters further includes: determining the cleaning time for the complex region C0 to be post-meal.

Optionally, in a case that the cleaning parameters include the cleaning frequency, the corresponding the plurality of screened candidate regions with different priorities to different cleaning parameters further includes: determining the cleaning frequency for the complex region C0 and the cleaning frequency for the nook and cranny region J0 to be at least once a week.

Optionally, in a case that the cleaning parameters include the cleaning frequency and the cleaning time, the corresponding the plurality of screened candidate regions with different priorities to different cleaning parameters further includes: determining the cleaning time for the complex region C0 to be post-meal; and determining the cleaning frequency of the complex region C0 and the cleaning frequency of the nook and cranny region J0 to be at least once a week.

Specifically, after the division and the sorting of the grid map 10 are completed, users may set a personalized cleaning strategy according to priorities of different regions to meet different cleaning requirements of the users.

In this embodiment, the cleaning frequency for the first priority region A is determined to be once a day, and the cleaning frequency for the second priority region B is determined to be every other day. Since the complex region C0 is a region with a dining table and a chair, the cleaning time for the complex region C0 is determined to be after meals. Since the complex region C0 and the nook and cranny region J0 are regions of less attention, the cleaning frequency for the complex region C0 and the cleaning frequency for the nook and cranny region J0 are determined to be once a week.

It should be noted that the cleaning parameters for cleaning regions in the cleaning strategy are not limited thereto, and other frequencies may be set for replacement. Optionally, the cleaning frequency for the first priority region A is determined to be two times, or three times, four times, or multiple times a day. Optionally, the cleaning frequency for the second priority region B is determined to be every three days, every four days, or every five days. Optionally, the cleaning time for the complex region C0 is determined to be after lunch. Optionally, the cleaning frequency for the complex region C0 and the cleaning frequency for the nook and cranny region J0 are determined to be two times, or three times, or four times a week.

In this embodiment, as for screened candidate regions 20 with different priorities, the cleaning the plurality of screened candidate regions 20 according to priority sorting includes: a) as for screened candidate regions with a same priority, determining a screened candidate region 20 with a largest size, in screened candidate regions (i.e., regions to be cleaned) with a same priority and closest to a cleaning device, as a priority cleaning region, and cleaning the priority cleaning region; b) cleaning remaining screened candidate regions (i.e., remaining regions to be cleaned) that are tangent to the priority cleaning region, and are in the screened candidate regions with a same priority, in a clockwise direction; and repeating the step a) and the step b) until the plurality of screened candidate regions with different priorities have been completely cleaned (i.e., until all regions to be cleaned have been thoroughly cleaned). The regions to be cleaned include the first priority region A, the second priority region B, the complex region C0 and the nook and cranny region J0.

Specifically, when the cleaning device performs region-by-region cleaning, a large region closest to the cleaning device is selected to start cleaning. During the cleaning process, the cleaning device starts at a center of a largest circle in the center and employs a spiral cleaning path to cover and clean the entire region, thereby ensuring that the entire region is thoroughly cleaned, and thus improving cleaning efficiency of the cleaning device.

In this embodiment, the cleaning the plurality of screened candidate regions includes:
cleaning each screened candidate region (i.e., each region to be cleaned) using a spiral cleaning path, starting at a center of the screened candidate region.

Specifically, using the above cleaning path ensures that the regions to be cleaned are thoroughly cleaned, further improving cleaning efficiency of a cleaning device. It should be noted that the cleaning path of the cleaning device is not limited thereto, and the cleaning path may be adjusted according to working conditions and usage requirements. Optionally, the cleaning device may start at the center of the region to be cleaned and use a zigzag cleaning path, a wavy cleaning path, or a serpentine cleaning path to clean the region to be cleaned.

In this embodiment, the cleaning remaining screened candidate regions that are tangent to the priority cleaning region, and are in the screened candidate regions with a same priority, in a clockwise direction includes:
selecting the remaining screened candidate regions that are tangent to the priority cleaning region, and are in the screened candidate regions with a same priority, in the clockwise direction, sequentially (i.e., selecting the regions to be cleaned that are tangent to the priority cleaning region in the clockwise direction, sequentially); and
entering each remaining screened candidate region through a gap between the remaining screened candidate region and the priority cleaning region, and cleaning the remaining screened candidate region using a spiral cleaning path, starting at a center of the remaining screened candidate region (i.e., entering each region to be cleaned through a gap between the region to be cleaned and the priority cleaning region, and cleaning the region to be cleaned using the spiral cleaning path, starting at the center of the region to be cleaned).

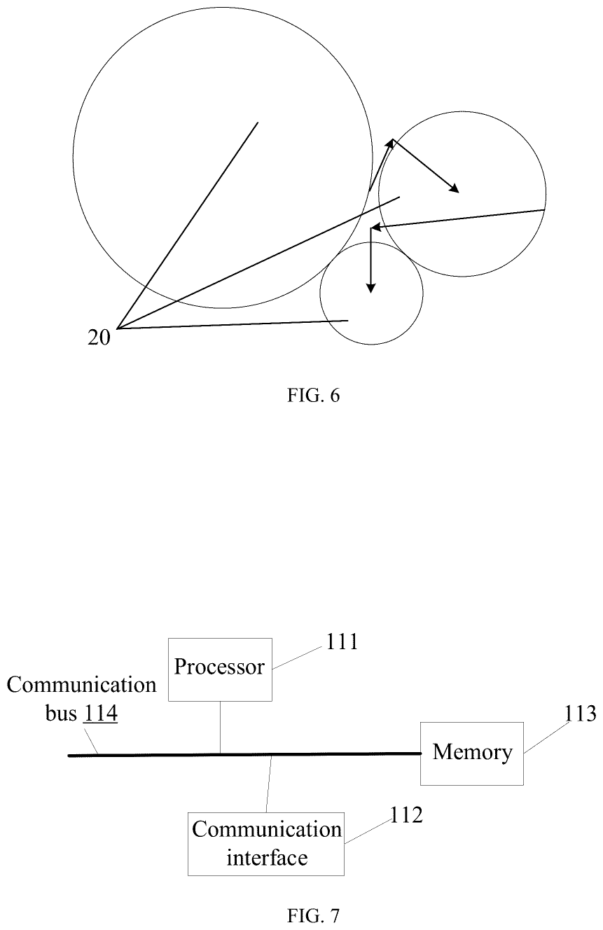

Specifically, after the cleaning of the priority cleaning region is completed, the cleaning device cleans the surrounding regions to be cleaned that are tangent to the priority cleaning region in the clockwise direction. When transitioning between regions, the cleaning device moves through the gap between the two regions to reach a center of a next region, so that the gap between the two circular regions can also be cleaned. The spiral cleaning path is shown in FIG. 6, and the arrows in FIG. 6 represent paths. After the cleaning of the current region is completed, the cleaning device selects a next large region closest to the current region for cleaning until all the large regions of a same type have been cleaned, and this cleaning session is now concluded.

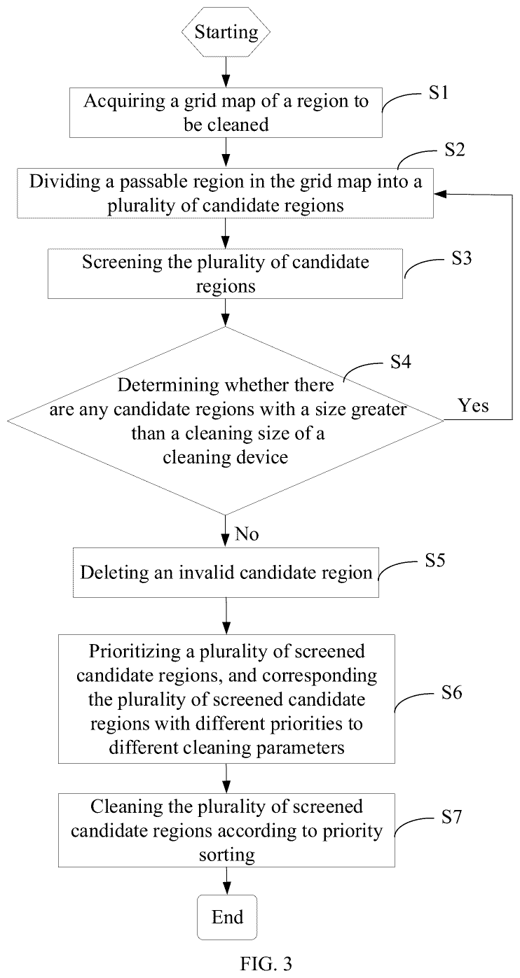

Specifically, as shown in FIG. 3, a cleaning method for a cleaning device includes the following content. The cleaning method for the cleaning device described in FIG. 3 is performed by a computing device (for example, a server), but the embodiments of the present application are not so limited.

S1, acquiring a grid map of a region to be cleaned. For example, the entire grid map is read.

S2, dividing a passable region in the grid map into a plurality of candidate regions.

S3, screening the plurality of candidate regions.

S4, determining whether there are any candidate regions with a size greater than a cleaning size of a cleaning device.

In a case that there are any candidate regions with a size greater than the cleaning size of the cleaning device, the steps S2 and S3 are repeated until there are no candidate regions with a size greater than the cleaning size of the cleaning device, and the plurality of screened candidate regions are obtained.

In a case that there are no candidate regions with a size greater than the cleaning size of the cleaning device, executing the step S5, deleting an invalid candidate region. For example, the candidate region with a radium less than or equal to a cleaning radium of the cleaning device is deleted.

S6, prioritizing a plurality of screened candidate regions, and corresponding the plurality of screened candidate regions with different priorities to different cleaning parameters.

S7, cleaning the plurality of screened candidate regions according to priority sorting.

As shown in FIG. 7, the present application further provides a robot vacuum cleaner, including: a processor 111, a communication interface 112, a memory 113, and a communication bus 114, and the processor 111, the communication interface 112, and the memory 113 communicate with each other through the communication bus 114.

The memory 113 is configured to store a computer program.

The processor 111 is configured to execute the computer program stored in the memory 113, implementing the cleaning method for the cleaning device described above.

The present application further provides a non-transitory computer-readable storage medium, on which a computer program is stored, and when the computer program is executed by a processor, the cleaning method for the cleaning device described above is implemented.

The present application further provides another robot vacuum cleaner, and the robot vacuum cleaner is configured to perform the cleaning method for the cleaning device described above.

The present application further provides another robot vacuum cleaner, including:
an acquiring unit, configured to acquire a grid map of a region to be cleaned;
a dividing unit, configured to divide a passable region in the grid map into a plurality of candidate regions;
a screening unit, configured to screen the plurality of candidate regions;
a prioritizing unit, configured to prioritize a plurality of screened candidate regions, and correspond the plurality of screened candidate regions with different priorities to different cleaning parameters; and
a cleaning unit, configured to clean the plurality of screened candidate regions according to priority sorting.

From the above description, it can be seen that the foregoing embodiments of the present application achieve the following technical effects.

The cleaning method for the cleaning device of the present application is applied, the passable region is first divided into the plurality of candidate regions, the plurality of candidate regions are screened, and then the plurality of screened candidate regions are prioritized, and the plurality of screened candidate regions with different priorities correspond to different cleaning parameters, so that a cleaning device may clean the plurality of screened candidate regions according to the priority sorting, which makes an optimized cleaning strategy better meet cleaning requirements of users. Compared to related technologies that do not consider different cleaning requirements for different regions to be cleaned, in the cleaning method for the cleaning device of the present application, the plurality of screened candidate regions are prioritized, and a cleaning strategy for the passable region is customized based on different cleaning parameters and different priorities, so as to solve the problems in that cleaning efficiency of a robot vacuum cleaner is relatively low in related technologies, thereby improving cleaning efficiency of a cleaning device, and thus avoiding energy waste and improving users' experience.

Apparently, the above-described embodiments are merely a part of the embodiments of the present application, rather than all of the embodiments. Based on the embodiments of the present application, all other embodiments obtained by a person skilled in the art without creative efforts shall fall within the protection scope of the present application.

It should be noted that the terms used herein are only for the purpose of describing specific embodiments and are not intended to limit the exemplary embodiments according to the present application. As used herein, unless otherwise explicitly stated in the context, the singular forms are also intended to include the plural forms. In addition, it should also be understood that, when the terms “contain” and/or “include” are used in this specification, it means that there are a feature, a step, an operation, a device, a component, and/or the combinations thereof.

It should be noted that the terms “first”, “second”, etc. in the specification and claims of the present application, as well as in the accompanying drawings, are used to distinguish similar objects and do not necessarily used to describe a specific order or sequence. It should be understood that the data used in this way may be interchanged in appropriate circumstances, so that the embodiments of the present application described herein can be implemented in an order other than those illustrated or described herein.

The above are only preferred embodiments of the present application and are not intended to limit the present application. For a person skilled in the art, there are various modifications and changes in the present application. Any modification, equivalent replacement, improvement, and the like made within the spirit and principle of the present application shall be included within the protection scope of the present application.

What is claimed is:

1. A cleaning method for a cleaning device, comprising:
acquiring a grid map of a region to be cleaned;
dividing a passable region in the grid map into a plurality of candidate regions;
screening the plurality of candidate regions;
prioritizing a plurality of screened candidate regions, and corresponding the plurality of screened candidate regions with different priorities to different cleaning parameters; and
cleaning the plurality of screened candidate regions according to priority sorting, wherein the cleaning parameters comprise at least one of a cleaning frequency, cleaning time, cleaning agent addition information and a cleaning mode.

2. The cleaning method for the cleaning device according to claim 1, wherein the dividing a passable region in the grid map into a plurality of candidate regions comprises:
with each pixel in the passable region as a center, extending radially until a non-passable region in the grid map is reached, so as to obtain a plurality of regions with preset shapes, and determining the plurality of regions with preset shapes as the plurality of candidate regions.

3. The cleaning method for the cleaning device according to claim 1, wherein the screening the plurality of candidate regions comprises:
determining at least one set of candidate regions with an intersecting relationship in the plurality of candidate regions; and
reserving a candidate region with an area greater than a preset threshold in each of the at least one set of candidate regions.

4. The cleaning method for the cleaning device according to claim 1, wherein after each screening of a plurality of candidate regions, a reserved candidate region is shielded, and then a remaining passable region, excluding the reserved candidate region, is divided into a plurality of candidate regions, the process continues until a size of each candidate region obtained through division is less than or equal to a cleaning size of a cleaning device.

5. The cleaning method for the cleaning device according to claim 1, further comprising:
deleting an invalid candidate region.

6. The cleaning method for the cleaning device according to claim 5, wherein the deleting an invalid candidate region comprises:
deleting a candidate region with a size less than or equal to a cleaning size of a cleaning device.

7. The cleaning method for the cleaning device according to claim 1, wherein the prioritizing a plurality of screened candidate regions comprises:
determining a screened candidate region with a size greater than a first preset value in the plurality of screened candidate regions as a first priority region;
determining a screened candidate region with a size greater than or equal to a second preset value and less than or equal to the first preset value in the plurality of screened candidate regions as a second priority region; and
determining a screened candidate region with a size less than the second preset value in the plurality of screened candidate regions as a third priority region;
wherein the second preset value is less than the first preset value.

8. The cleaning method for the cleaning device according to claim 7, wherein the prioritizing a plurality of screened candidate regions further comprises:
determining a screened candidate region that is tangent to or in contact with the first priority region as the first priority region.

9. The cleaning method for the cleaning device according to claim 7, wherein the prioritizing a plurality of screened candidate regions further comprises:
determining a region formed by at least three third priority regions that are tangent to each other as a complex region.

10. The cleaning method for the cleaning device according to claim 7, wherein the prioritizing a plurality of screened candidate regions further comprises:
determining the third priority region that is tangent to the second priority region as the second priority region, and in a case that the second priority region has been determined as the first priority region, determining the third priority region that is tangent to the second priority region as the first priority region.

11. The cleaning method for the cleaning device according to claim 9, wherein the prioritizing a plurality of screened candidate regions further comprises:
determining the third priority region isolated in the grid map as a nook and cranny region.

12. The cleaning method for the cleaning device according to claim 7, wherein in a case that the cleaning parameters comprise the cleaning frequency, the corresponding the plurality of screened candidate regions with different priorities to different cleaning parameters comprises:
determining the cleaning frequency for the first priority region to be at least once a day; and
determining the cleaning frequency for the second priority region to be at least once every two days.

13. The cleaning method for the cleaning device according to claim 9, wherein in a case that the cleaning parameters comprise the cleaning time, the corresponding the plurality of screened candidate regions with different priorities to different cleaning parameters further comprises:
determining the cleaning time for the complex region to be post-meal.

14. The cleaning method for the cleaning device according to claim 11, wherein in a case that the cleaning parameters comprise the cleaning frequency, the corresponding the plurality of screened candidate regions with different priorities to different cleaning parameters further comprises:
determining the cleaning frequency for the complex region and the cleaning frequency for the nook and cranny region to be at least once a week.

15. The cleaning method for the cleaning device according to claim 11, wherein in a case that the cleaning parameters comprise the cleaning frequency and the cleaning time, the corresponding the plurality of screened candidate regions with different priorities to different cleaning parameters further comprises:
determining the cleaning time for the complex region to be post-meal; and
determining the cleaning frequency of the complex region and the cleaning frequency of the nook and cranny region to be at least once a week.

16. The cleaning method for the cleaning device according to claim 1, wherein the cleaning the plurality of screened candidate regions according to priority sorting comprises:
a) as for screened candidate regions with a same priority, determining a screened candidate region with a largest size, in screened candidate regions with a same priority and closest to a cleaning device, as a priority cleaning region, and cleaning the priority cleaning region;
b) cleaning remaining screened candidate regions that are tangent to the priority cleaning region, and are in the screened candidate regions with a same priority, in a clockwise direction; and
repeating the step a) and the step b) until the plurality of screened candidate regions with different priorities have been completely cleaned.

17. The cleaning method for the cleaning device according to claim 1, wherein the cleaning the plurality of screened candidate regions comprises:
cleaning each screened candidate region using a spiral cleaning path, starting at a center of the screened candidate region.

18. The cleaning method for the cleaning device according to claim 16, wherein the cleaning remaining screened candidate regions that are tangent to the priority cleaning region, and are in the screened candidate regions with a same priority, in a clockwise direction comprises:
selecting the remaining screened candidate regions that are tangent to the priority cleaning region, and are in the screened candidate regions with a same priority, in the clockwise direction, sequentially; and
entering each remaining screened candidate region through a gap between the remaining screened candidate region and the priority cleaning region, and cleaning the remaining screened candidate region using a spiral cleaning path, starting at a center of the remaining screened candidate region.

19. A robot vacuum cleaner, comprising: a processor, a communication interface, a memory, and a communication bus, wherein the processor, the communication interface, and the memory communicate with each other through the communication bus;
the memory is configured to store a computer program; and
the processor is configured to execute the computer program stored in the memory, implementing a cleaning method for a cleaning device, and the cleaning method for the cleaning device comprises:
acquiring a grid map of a region to be cleaned;
dividing a passable region in the grid map into a plurality of candidate regions;
screening the plurality of candidate regions;
prioritizing a plurality of screened candidate regions, and corresponding the plurality of screened candidate regions with different priorities to different cleaning parameters; and
cleaning the plurality of screened candidate regions according to priority sorting, wherein the cleaning parameters comprise at least one of a cleaning frequency, cleaning time, cleaning agent addition information and a cleaning mode.

20. A non-transitory computer-readable storage medium, on which a computer program is stored, wherein when the computer program is executed by a processor, a cleaning method for a cleaning device is implemented, and the cleaning method for the cleaning device comprises:
acquiring a grid map of a region to be cleaned;
dividing a passable region in the grid map into a plurality of candidate regions;
screening the plurality of candidate regions;
prioritizing a plurality of screened candidate regions, and corresponding the plurality of screened candidate regions with different priorities to different cleaning parameters; and
cleaning the plurality of screened candidate regions according to priority sorting, wherein the cleaning parameters comprise at least one of a cleaning frequency, cleaning time, cleaning agent addition information and a cleaning mode.
